(19) United States
(12) Patent Application Publication
(10) Pub. No.: US 2024/0092949 A1
(43) Pub. Date: Mar. 21, 2024

(54) CONTINUOUS PROCESS FOR POLYMERIZATION OF VINYL CHLORIDE

(71) Applicant: Braskem S.A., Camaçari (BR)

(72) Inventors: Normando José Castro de Jesus, São Paulo City (BR); Márcio Henrique dos Santos Andrade, São Paulo City (BR); Antonio Luiz Duarte Bragança, São Paulo City (BR); Priscila Martins Beck, São Paulo City (BR); Rita Cristina C. Marinho, São Paulo City (BR); Tahyná Barbalho Fontoura, São Paulo (BR); Nathalia Oliveira Martins, São Paulo City (BR); Thiago Roberto Almeida, São Paulo (BR); John Henry Percival Brooman, São Paulo City (BR)

(73) Assignee: Braskem S.A., Camaçari (BR)

(21) Appl. No.: 18/241,735

(22) Filed: Sep. 1, 2023

Related U.S. Application Data
(60) Provisional application No. 63/403,206, filed on Sep. 1, 2022.

(51) Int. Cl. C08F 14/06; B01J 19/00; B01J 19/18

(52) U.S. Cl. CPC C08F 14/06; B01J 19/006; B01J 19/1831; B01J 2219/00777

(57) ABSTRACT

A process for polymerization of vinyl chloride may include contacting vinyl chloride, demineralized water, at least one stabilizer agent, at least one dispersing agent, an initiator and optionally one or more comonomers; continuously feeding the vinyl chloride, demineralized water, at least one stabilizer agent, at least one dispersing agent, an initiator and optionally one or more comonomers into a tubular reactor having a length of at least 20 times an internal diameter of the tubular reactor; and continuously polymerizing the vinyl chloride, and optionally the one or more comonomers.

### BACKGROUND

Polyvinyl chloride (PVC) belongs to the group of the most important commercial plastic materials. As a general-purpose resin, polyvinyl chloride is widely used in the world. Polyvinyl chloride products play an important role through solutions with excellent cost/benefit for infrastructure and civil construction, in addition to its use in footwear, packaging, toys, technical laminates and other durable goods.

Polyvinyl chloride polymerization follows the chain reaction route via free radicals, in which the vinyl chloride monomer is dispersed in water. Depending on the reactor conditions, the dispersion occurs in the form of suspension, emulsion, or micro-suspension. Emulsion process accounts for 10% of the polyvinyl chloride production in the world, mainly for liquid compounds applications. Approximately 80% of the polyvinylchloride consumed in the world is produced through suspension polymerization.

For the emulsion type process, liquid vinyl chloride monomer is finely dispersed in droplets in the diameter range of 0.1 to 1 μm in an aqueous phase, by vigorous agitation and the presence of an emulsifying agent. Typical emulsifying agents are sodium and ammonium salts of sulfated alcohols, alkyl sulfonates, sulfosuccinates.

Initiators are used as free radicals for polymerization reaction. They need to be soluble in water and the most commonly used are potassium or ammonium persulfates. The reaction is highly exothermic and agitation as well as heat removal through a cooling system are critical to the process.

For emulsion type polymerization process, the conversion of vinyl chloride monomer in a batch reaction can reach 95%. Up to 70% of conversion, the pressure inside the batch reactor is constant and on higher conversions the pressure decreases due to the depletion of liquid monomer in the system. As all the liquid monomer is consumed, pressure decreases and reaction rate reduces significantly, making it no longer economically viable to increase conversion.

In the traditional suspension polymerization process for polyvinylchloride, production is conducted in a set of batch reactors, mechanically stirred, with a cooling system to remove the heat generated during polymerization. Into these batch reactors are charged demineralized water, vinyl chloride monomer, initiators, stabilizer and dispersing agents.

In the batch reactor, the vinyl chloride monomer is dispersed in droplets with a diameter between 30 and 200 μm, in an aqueous phase, by vigorous agitation and a protective colloid, also called dispersing agent or suspending agent. The dispersing agents are water-soluble organic polymers or systems based on inorganic particles. The most common are poly vinyl alcohols and substituted cellulose, such as hydroxyethyl cellulose (HEC), methyl cellulose, hydroxypropyl methyl cellulose and hydroxypropyl cellulose. Choosing the type of dispersing system is extremely important, as it controls the particle size of the resin produced, its structure internal morphology and porosity.

Vinyl chloride monomer is dispersed into water by agitation and the reactors are warmed up to a certain temperature in order to decompose the initiator, generating highly energetic species capable of interacting with the double bond present in the vinyl chloride monomer. Initiators commonly used in suspension polymerization of vinyl chloride monomer are peroxydicarbonates, diacyl peroxides and peroxide esters.

As the polyvinyl chloride polymerization reaction is exothermic, cooling water circulates in the reactor's jacket to control the systems temperature. After some time, a major part of liquid vinyl chloride monomer is converted to polyvinyl chloride, the reaction pressure goes down and the polymerization reaction is stopped. At the end of each batch, the unreacted vinyl chloride monomer is recovered, polyvinylchloride slurry is discharged, and the reactor must be cleaned, refilled and reheated. Slurry from the reactor is blended in the slurry tank with batches from other several reactors. Then slurry is fed to the dehydrator, and wet cake is fed to the dryer. After removing coarse particles by the screen, dried polyvinyl chloride powder is transferred to final product storage.

In the state of art of vinyl chloride monomer suspension polymerization technology, large reactors are successfully adopted to increase residence time and heat transfer capacity, consequently increasing production rate. However, in the suspension polymerization technology, the large reactors in a batch type operation require large installations and there is a significant volume of vinyl chloride monomer reacting at higher conversion and heat releasing rates. Moreover, in the batch reactors, all raw material and additives, including initiators, are charged at once, before the start up, therefore, there is a higher operational risk. Furthermore, the batch wise operation requires several manual operations and productivity is limited due to the downtime between batches.

Since the early 1960s, pilot trials of continuous suspension polymerization of polyvinylchloride in a tube reactor failed due to very rapid fouling of the reactor tube surfaces and poor particle size control. The continuous production of polyvinyl chloride in tubular plug flow reactors is problematic, since the slow rate reaction requires long residence times, and consequently long tubular reactors result in high pressure drops and low flow rates with poor mixing. At lower flow rates the polymer tends to deposit on the internal surfaces of the reactor leading to fouling issues and even blockage of the reactor.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a process for polymerization of vinyl chloride, that includes contacting vinyl chloride, demineralized water, at least one stabilizer agent, at least one dispersing agent, an initiator and optionally one or more comonomers; continuously feeding the vinyl chloride, demineralized water, at least one stabilizer agent, at least one dispersing agent, an initiator and optionally one or more comonomers into a tubular reactor having a length of at least 20 times an internal diameter of the tubular reactor; and continuously polymerizing the vinyl chloride, and optionally the one or more comonomers.

In another aspect, embodiments disclosed herein relate to a polyvinyl chloride polymer produced by contacting vinyl chloride, demineralized water, at least one stabilizer agent, at least one dispersing agent, an initiator and optionally one or more comonomers; continuously feeding the vinyl chloride, demineralized water, at least one stabilizer agent, at least one dispersing agent, an initiator and optionally one or more comonomers into a tubular reactor having a length of at least 20 times an internal diameter of the tubular reactor; and continuously polymerizing the vinyl chloride, and optionally the one or more comonomers.

Other aspects and advantages of the claimed subject matter will be apparent from the following description and the appended claims.

### BRIEF DESCRIPTION OF DRAWINGS

FIG. 1 shows a process flow diagram according to one or more embodiments.

FIG. 2 shows a process flow diagram according to one or more embodiments, including a pre-polymerization step.

FIG. 3 depicts an oscillatory tubular reactor according to one or more embodiments.

FIG. 4 depicts various types of internal baffles used in an oscillatory tubular reactor according to one or more embodiments.

FIG. 5 depicts a twisted tube used in an oscillatory tubular reactor according to one or more embodiments.

FIG. 6 depicts a corrugated tube used in an oscillatory tubular reactor according to one or more embodiments.

FIG. 7 shows the particle size distribution for the experimental trial described in Example 1.

FIG. 8 illustrates reaction conversion along reactor length, for simulations 1, 2 and 3

FIG. 9 shows the results for particle size distribution, on simulations 1, 2 and 3.

FIG. 10 compares particle size distribution from the three simulation scenarios to the particle size distribution of the experimental trial.

FIG. 11 shows particle size distribution for simulations 3 and 4, with different initial droplet diameters.

FIG. 12 depicts the computational domain for the baffled tube with the cross-section area.

FIG. 13 depicts the computational domain of the twisted tube, with the cross-section area and a detail of the reactor torsions.

FIG. 14 depicts the streamlines and time-average values for energy dissipation and shear stress during a flow cycle in a baffled tube oscillatory reactor and in a twisted tube oscillatory reactor.

FIG. 15 compares energy dissipation in a baffled tube and a twisted tube.

FIG. 16 shows the relationship between particle diameter and energy dissipation on a twisted tube and a baffled tube.

FIG. 17 shows the particle size distribution for samples of the pre-polymerization reactor, described in example 5.

FIGS. 18 and 19 show the results of scanning electron microscopy (SEM) for the polymer particles obtained on a pre-polymerization trial.

### DETAILED DESCRIPTION

Embodiments disclosed herein are directed to the use of a continuous oscillatory reactor for production of polyvinyl chloride. Use of continuous oscillatory tubular reactor, which may be baffled or not, to form polyvinyl chloride may present advantages in terms of more compact dimension, less energy consumption, and cleaner operation, leading to longer campaigns. Finally, a plug flow configuration would also permit product enhancement and differentiation through incremental additions or removals of reaction matter along the continuous oscillatory tubular length in order to control and tailor structures, molecular weight, as well as perform multiple and incremental initiator addition.

Embodiments disclosed herein relate to a method of polyvinyl chloride production in continuous mode, based on the suspension polymerization process, where vinyl chloride monomer, under pressure, is dispersed as droplets in water and polymerized using free radical initiators. The reaction is carried inside an oscillatory tubular reactor, baffled or not, which provides high shear rates and turbulence of the liquid mixture even at low volumetric rates. The turbulent liquid flow, produced by the oscillatory movement, allows the adequate mixing of the components, and prevents deposition of polyvinyl chloride on the internal surfaces of the reactor.

A continuous process for polymerization of vinyl chloride monomer is based on the suspension polymerization process, where vinyl chloride monomer under pressure range of 10 to 40 barg and temperature range of 30° C. to 80° C. in a residence time up to 180 minutes. The vinyl chloride monomer is dispersed as droplets in water and polymerized using organic peroxides as free radical initiators. The continuous reaction is carried inside an oscillatory tubular reactor, which provides high shear rates and turbulence of the liquid mixture even at low volumetric rates.

According to the present invention, concentration of vinyl chloride is at least 10 wt % and up to 60 wt %, based on the amount of demineralized water.

In one aspect, the embodiment disclosed herein relates to a method of polyvinylchloride production in continuous mode, based on the suspension polymerization process, where vinyl chloride monomer, pressure range of 10 to 40 barg and temperature range of 30° C. to 80° C. in a residence time up to 180 minutes. The vinyl chloride monomer is dispersed as droplets in water and polymerized using organic peroxides as free radical initiators. Previously to the reaction step, there is a pre-mixing step, which consists of jacketed stirred vessel where vinyl chloride monomer is mixed with demineralized water, a processing stabilizer optionally based on phenol and polyvinyl alcohol as primary and secondary dispersing agents. The pre-mixture is added into the reactor and initiator can be added in one or more different points of the oscillatory tubular reactor, since it is added at least at a distance of at least 10 times the internal diameter of the tubular reactor from the piston pump discharge point. The oscillatory tubular reactor, baffled or not, provides high shear rates and turbulence of the liquid mixture even at low volumetric rates. The turbulent liquid flow, produced by the oscillatory movement, allows the adequate mixing of the components.

According to the present invention, initiators can be organic peroxides, hydrogen peroxide and azo compounds or mixtures thereof. In the process according to the present invention, initiators are used in an amount from 0.02 to 0.15 parts per hundred of monomers.

According to the present invention, stabilizers optionally based on phenol and can be alkyl/aryl phosphites, epoxy compounds, modified soy oils, beta-diketones, amino crotonates, nitrogen heterocyclic compounds, organosulfur compounds (i.e., ester thiols), hindered phenolics, and polyols (pentaerythritols), or mixtures thereof. In the process according to the present invention, stabilizers are used in an amount from 0.0005 to 0.003 parts per hundred of monomers.

According to the invention, dispersing agents are capable of providing colloidal protection and/or tensoative action and can be polyvinyl alcohols, cellulosic compounds, or mixtures thereof. In the process according to the present invention, dispersing agents are used in an amount from 0.05 to 0.25 parts per hundred of monomers.

In other aspect, the embodiment disclosed herein relates to a method of polyvinylchloride production in continuous mode, based on the suspension polymerization process, where vinyl chloride monomer, pressure range of 10 to 40 barg and temperature range of 30° C. to 80° C. in a residence time up to 180 minutes. The vinyl chloride monomer is dispersed as droplets in water and polymerized using organic peroxides as free radical initiators. In the reaction step, there is a pre-mixing zone, which occurs from the inlet of the oscillatory tubular reactor, where the vinyl chloride monomer is mixed with demineralized water, a processing stabilizer optionally based on phenol and polyvinyl alcohol as primary and secondary dispersing agents. The initiator can be added in one or more different points of the oscillatory tubular reactor, since it is added at least at a distance of at least 10 times the internal diameter of the tubular reactor from the piston pump discharge point. The oscillatory tubular reactor, baffled or not, provides high shear rates and turbulence of the liquid mixture even at low volumetric rates. The turbulent liquid flow, produced by the oscillatory movement, allows the adequate mixing of the components.

In another aspect, the embodiment disclosed herein relates to a method of polyvinyl chloride production in continuous mode, based on the suspension polymerization process, where vinyl chloride monomer, pressure range of 10 to 40 barg and temperature range of 30° C. to 80° C. in a residence time up to 180 minutes. The vinyl chloride monomer is dispersed as droplets in water and polymerized using organic peroxides as free radical initiators. Previously to the reaction step, there is a pre-mixing step, which consists of a jacketed stirred vessel where vinyl chloride monomer is mixed with demineralized water, a processing stabilizer optionally based on phenol, polyvinyl alcohol as primary and secondary dispersing agents and part of the initiator. With part of the initiator being added in the pre-mixture vessel, there will be a pre-polymerization step, prior to the oscillatory tubular reactor. Other parts of initiator can be added in one or more different points of the oscillatory tubular reactor, since it is added at least at a distance of at least 10 times the internal diameter of the tubular reactor from the piston pump discharge point.

In yet another aspect, the embodiment disclosed herein relates to a method of polyvinylchloride production in continuous mode, based on the suspension polymerization process, where vinyl chloride monomer, pressure range of 10 to 40 barg and temperature range of 30° C. to 80° C. in a residence time up to 180 minutes. The vinyl chloride monomer is dispersed as droplets in water and polymerized using organic peroxides as free radical initiators. There are no pre-mixing vessels. The pre-mixing occurs from the inlet of the reactor, and pre-polymerization, occurs inside the oscillatory tubular reactor from the moment and the point the initiator is added. Therefore, vinyl chloride monomer is mixed with demineralized water, a processing stabilizer optionally based on phenol, polyvinyl alcohol as primary and secondary dispersing agents, and part of the initiator. Temperature control, residence time and initiator concentration ensure pre-polymerization, in the first section of the oscillatory tubular reactor. Other parts of initiator can be added in one or more different points of the oscillatory tubular reactor, since it is added at least at a distance of at least 10 times the internal diameter of the tubular reactor from the piston pump discharge point.

For all the embodiments disclosed, the reaction itself occurs in the oscillatory tubular reactor. Moreover, there is a post-reaction step that consists of a vessel for the accumulation of the reaction medium, at the exit of the reactor, pressurized with inert gas, making it also act as a pulsation damper of the reactor, preventing pressure oscillation effects therein. The vessel will require agitation, to avoid precipitation and consequently lumps formation of the reacted polyvinylchloride. This vessel will feed the later stages of the system, such as the centrifugation and drying of the polyvinylchloride.

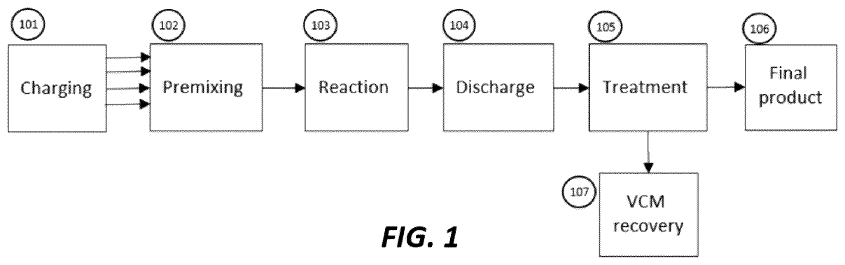

Referring to FIG. 1, a process flow diagram that depicts steps for one or more embodiments of polyvinyl chloride production is shown. Firstly, in charging step 101, dispersing agents, stabilizer, and initiator are charged to different vessels. Secondly, in a pre-mixing step 102, vinyl chloride monomer is mixed with demineralized water, to which a processing stabilizer optionally based on phenol and polyvinyl alcohols are added as primary and secondary dispersing agents. In one or more embodiments, this pre mixing occurs as a batch type operation inside a pre-mixing vessel where vinyl chloride monomer is dispersed as droplets in water. The pre-mixing vessel may include jacketed stirred system where the vinyl chloride monomer is mixed with demineralized water, processing stabilizer and dispersing agents. In another embodiment of the present invention, this pre-mixing occurs as a continuous type of operation.

Reaction 103 then occurs in an oscillatory tubular reactor. Pre-mixture from pre mixing vessel in pre-mixing step 102 is transferred using a pump and flowmeters to control the flow. The polymerization reaction 103 of polyvinyl chloride is carried out in a pressure range of 10 to 40 barg and temperature range of 30° C. to 80° C. and a residence time up to 180 minutes. The vinyl chloride monomer is dispersed as droplets in water and polymerized using organic peroxides as free radical initiator. The initiator can be added in one or more different points of the oscillatory tubular reactor, since it is added at least at a distance of at least 10 times the internal diameter of the tubular reactor from the piston pump discharge point.

In other embodiments, however, pre-mixing 102 does not occur in a pre-mixing vessel, but instead in a pre-mixing zone of the oscillatory tubular reactor, which occurs from the inlet of the reactor. After charging step 101, the vinyl chloride monomer, demineralized water, stabilizers, and dispersing agents are added to the reactor using pumps and flowmeters to ensure continuous flow to the suction of reactor's piston pump. Inside the reactor, there is a pre-mixing zone, which occurs from the inlet of the oscillatory tubular reactor (prior to the initiator feed), where the vinyl chloride monomer is mixed with demineralized water, a processing stabilizer optionally based on phenol and polyvinyl alcohols as primary and secondary dispersing agents in pre-mixing step 102. The organic peroxide, which acts as free radical initiator for the polymerization can be added in one or more different points of the oscillatory tubular reactor, since it is added at least at a distance of at least 10 times the internal diameter of the tubular reactor from the piston pump discharge point. The oscillatory tubular reactor, baffled or not, provides high shear rates and turbulence of the liquid mixture even at low volumetric rates. The turbulent liquid flow, produced by the oscillatory movement, allows the adequate mixing of the components. The polymerization reaction 103 of polyvinyl chloride is carried out in a pressure range of 10 to 40 barg and temperature range of 30° C. to 80° C. in a residence time up to 180 minutes.

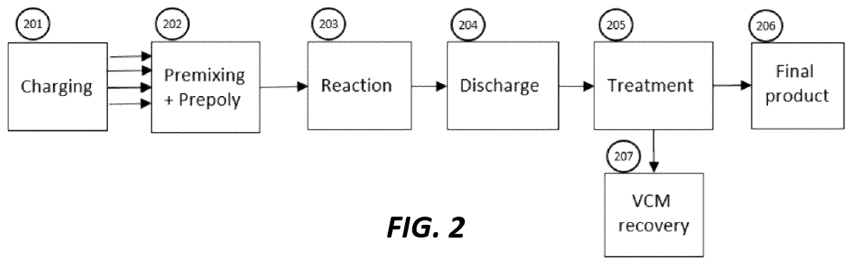

Referring to FIG. 2, a process flow diagram that depicts the steps for one or more embodiments of polyvinyl chloride production is shown. Firstly, in charging step 201, dispersing agents, stabilizer and initiator are charged to different vessels. Secondly, in a pre-mixing step 202, vinyl chloride monomer is mixed with demineralized water, to which a processing stabilizer optionally based on phenol and polyvinyl alcohols are added as primary and secondary dispersing agents. In one or more embodiments, this pre mixing occurs as a batch type operation inside a pre-mixing vessel where vinyl chloride monomer is dispersed as droplets in water to form a pre-mixture, and the pre-mixture can then be fed with enough volume into a reactor such that polymerization of the vinyl chloride occurs continuously. The reactor is an oscillatory tubular reactor. The pre mixing vessel may include jacketed stirred system where the vinyl chloride monomer is mixed with demineralized water, a processing stabilizer and dispersing agents. Part of the organic peroxide initiator can be added to the pre-mixing vessel for a pre-polymerization, under temperature and residence time control of the pre-polymerization. Residence time for the pre-polymerization inside the pre-mixing vessel is within the range of 10 to 60 minutes.

In another embodiment of the present invention, this pre-mixing and pre-polymerization occurs as a continuous type of operation with the same conditions.

The pre-polymerization ensures controlled particle size distribution to polyvinyl chloride particles. Other parts of initiator can be added in one or more different points of the oscillatory tubular reactor. Reaction 203 then occurs in the oscillatory baffled tubular reactor. Pre-mixture from pre-mixing vessel in pre-mixing step 202 is transferred using a pump and flowmeters to control the flow of pre-mixture from the outlet of pre-mixing vessel to reactor. The polymerization reaction 203 of polyvinyl chloride is carried out in a pressure range of 10 to 40 barg and temperature range of 30° C. to 80° C. in a residence time of at least 10 minutes, 20 minutes, or 30 minutes, and up to 180 minutes.

In other embodiments, however, pre-mixing 202 does not occur in a pre-mixing vessel, but instead in a pre-mixing zone of the oscillatory tubular reactor, which occurs from the inlet of the reactor. After charging step 201, the vinyl chloride monomer, demineralized water, a processing stabilizer optionally based on phenol, polyvinyl alcohol as primary and secondary dispersing agents and part of the initiator are fed, preferably continuously, to the reactor in the suction of its piston pump. That is, in such embodiments, there is no pre-mixing vessel, and the pre-mixing step and pre-polymerization 202, are continuous operations that occur inside the reactor, occurs from the inlet, prior to the initiator feed. Vinyl chloride monomer is dispersed as droplets in water and polymerized, preferably continuously, using organic peroxides as free radical initiators. Temperature control and initiator concentration ensure pre-polymerization, in the first section of the oscillatory tubular reactor. Other parts of initiator can be added in one or more different points of the oscillatory tubular reactor for the polyvinyl chloride polymerization reaction 203, which carried out in a pressure range of 10 to 40 barg and temperature range of 30° C. to 80° C. in a residence time up to 180 minutes.

Thus, multiple embodiments are envisioned: for example, pre-mix may occur in a pre-mixing vessel. The pre-mixture is prepared in a batch with enough volume to continuously feed the oscillatory reactor and ensure the polymerization reaction in a continuous mode. In another example, there is no pre-mix vessel, and the mixture occurs inside the continuous oscillatory reactor, i.e., from the inlet of the reactor and prior to the initiator feed. In another example, the pre-mix vessel is also a pre-polymerization step. Part of the initiator is added to the pre-mixture vessel, and there is pre-polymerization, prior to the oscillatory tubular reactor. The pre-polymerized flow is continuously fed to the oscillatory tubular reactor. In yet another example, there is no pre-mix vessel and the mixing as well as pre-polymerization occurs in the reactor, from the moment and the point the initiator is added.

For all the embodiments disclosed, the reaction itself occurs in the oscillatory jacketed tubular reactor. By virtue of the method, the rate of conversion of the monomer is high. It advantageously varies from 80% to 100%, for example from 90% to 100%.

Upon completion of the polymerization, the polyvinyl chloride may be separated from unreacted monomer, dried, and then additivated. The post reaction steps 104, 105, 106, 107 in FIG. 1 are identical to post reaction steps 204, 205, 206 and 207, respectively, in FIG. 2. During discharge step 104, a vessel is at the exit of the reactor, pressurized with inert gas, making it act as a pulsation damper of the reactor, preventing pressure oscillation effects therein. Such vessel receives the accumulation of the reaction medium being discharged. The vessel is agitated to avoid precipitation and consequently lumps formation of the reacted polyvinyl chloride. This vessel can receive production of one or more reactors and will feed the later stages of the system, vinyl chloride monomer recovery 107 and treatment 105. Unreacted vinyl chloride monomer is vaporized and vented into a vinyl chloride monomer treating system for recovery 107.

The polyvinyl chloride separated in discharge 104 is transferred to treatment step 105, where the polymer flows to a centrifugation operation, followed by drying to form final product 106. Optionally, polyvinyl chloride powder may have plasticizers and other liquid additives incorporated and is ready for final product storage.

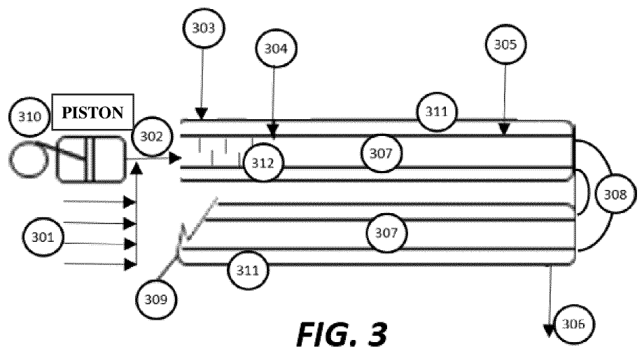

Referring to FIG. 3, a continuous oscillatory tubular reactor is shown. Optionally, continuous oscillatory reactors can be baffled or not. As shown, a tubular reactor is generally represented as having tubular sections 307 connected by U-connectors 308. The term “tubular” is intended to mean a reactor of which the straight length is much larger than the section. The tubular reactor comprises at least one tubular section having a length Ls and an internal diameter D with Ls being at least 20 times larger than the internal diameter D. Ls may be identical to total length of the tubular reactor L_{R}.

The reactor comprises an inlet 302 and an outlet 309, at the end of the last tubular section. As previously mentioned, the reactor can have multiple tubular sections, connected by U-connectors. Along tubular sections 307 and U-connectors 308 are access ports 304 and 305 which may be an inlet/outlet. The tubular reactor can have multiple access ports such as 304 and 305 in different reactor sections and may be or not equidistant. Into access ports 304 and 305, it is possible to introduce the initiator, demineralized water, killers, or any other intended chemical, as well as it is also possible to take, for example, samples of product from reactor. It is also possible to insert measurement and/or control instruments, probes, or sensors, making it possible in particular to measure, online or continuously, for example and not limited to the temperature, the pressure, the rate of conversion and the viscosity.

Outlet 309 can be equipped with an outlet valve to control the amount of polyvinyl chloride exiting the vessel through the outlet, and to provide a residence time of at least 10 minutes, 20 minutes, or 30 minutes, and up to 180 minutes between the moment vinyl chloride monomer is injected into the reactor and a polyvinylchloride polymer exits the reactor at the outlet 309.

Adjacent inlet 302, the reactor is connected to an external device 310, such as a piston arrangement, which makes it possible to subject the fluid within the reactor to an oscillatory movement. This device may, for example, be a hydraulic piston, with one or more membranes, or a mechanical piston. The device 310 creates positive and negative displacement of liquid at a previously adjusted frequency. The oscillatory liquid displacement provides thorough mixing and turbulence inside the reactor. The amplitude combined with frequency defines the level of turbulence inside the oscillatory tubular reactor, which is a critical factor to define particle size distribution of the polymerization reaction. The pair frequency and amplitude will be limited as the higher the product of frequency and amplitude is, the higher will be the pressure in the system.

In one or more embodiments, the amplitude of the oscillatory movement may vary up to 10 times the internal diameter of the tubular reactor section 307.

In one or more embodiments, the frequency of the oscillatory movement may vary up to 5 Hz.

In one embodiment, the reactor comprises at least one device which makes it possible to provide or discharge heat, such as sections of jacket, allowing control of the temperature which may be different from one area to the other. As required, the means can reheat or cool certain sections of the tubular reactor. It is envisioned that a jacket, or at least a jacket segment 311, would make it possible to control and maintain a constant temperature or a uniform temperature profile gradient in the oscillatory tubular reactor by means of a source of heat (like steam, circulating hot fluid) or a circulating coolant (like cooling or chilled fluid). Fluid inlet 303 and fluid outlet 306, can be specific to one jacket section or multiple jacket sections. While not illustrated, the fluid circulation in the jacket should be provided by a pump. For example, the jacket may be used to maintain the temperature of the reaction between 30° C. to 80° C. Hot fluid circulation might be needed to heat the oscillatory reactor, promote decomposition of the initiator, and form free radicals, therefore to initiate the polymerization. Cooling fluid will be circulated in order to maintain reaction temperature. Moreover, the oscillatory tubular reactor may also be pressurized, such as a pressure from 10 to 40 barg.

The method according to the present disclosure makes it possible to efficiently control the molecular weight and porosity of the polyvinyl chloride formed. Increasing the polymerization temperature has the opposite effect on the average molecular weight of the resin produced, the higher the polymerization temperature, the lower the molecular weight of the polyvinyl chloride obtained. This is due to the fact that the polymerization reaction is based on mechanisms via free radicals, therefore, greater temperatures imply higher decomposition rates of the initiators, that is, a greater amount of free radical species for the unreacted vinyl chloride monomer. The polymerization temperature also has a strong effect on the porosity of the particles obtained: lower polymerization temperatures imply higher particle porosity values.

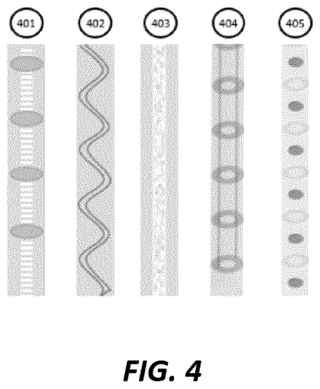

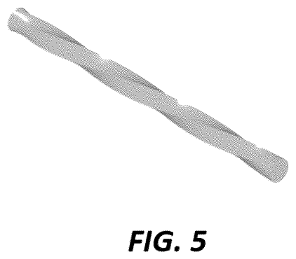

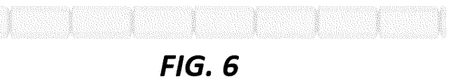

To obtain the adequate mixing intensity, the continuous oscillatory tubular reactor can combine the oscillatory flow of the liquid medium with internal obstacles in the tubes, which divert the flow of the reaction medium and favor its agitation (by the formation of reciprocal eddies). Such obstacles can be designed as—but not limited to—baffles shown in FIG. 4, twisted tubes shown in FIG. 5, or corrugated tubes shown in FIG. 6.

For example, baffles can be in the form of square-edged, sharp, or smooth baffles. In relation to the reactor wall, it can be positioned at right or acute angles, in the form of rings, wires or washers. Distinct types of baffles are depicted as central axial baffles 401, round edged helical baffles 402, wire wool baffles 403, single-orifice baffles 404, disc and doughnut baffles 405.

Instead of baffles, in one or more embodiments, the tube wall itself can be shaped to create obstacles, as is the case with twisted (with different profiles such as flat oval, oval, among others) or corrugated tubes, or other wall shape configurations.

The shape and the spacing of the baffles can be adjusted according to the progression of the polymerization reaction, and thus can be different in the areas where the polymerization begins, in the areas where the polymerization is ongoing, and in the areas where the polymerization ends. The presence of baffles or internal obstacles is necessary during the polymerization method.

As shown in FIG. 3, the baffles 312 are present in each tubular section 307, as well as in the U-connectors 308, and create cells between adjacent baffles 312. Each baffled cell may act as a continuous stirred tank reactor. By changing variable values such as baffle spacing or thickness or obstacles shapes and configuration, with an appropriate range of amplitude and frequency of the oscillation, the reactor can operate with much better mixing control as compared to conventional tubular reactors. The baffles are spaced regularly or irregularly, apart by a distance advantageously ranging from the inner diameter of the tubular section 307 to three times the inner diameter of the tubular section (i.e., 1D to 3D), anyhow allowing homogeneity to be maintained.

While FIG. 3 shows a single section reactor that has two tubular jacketed sections 307 connected by a U-connector 308, one tubular reactor can have multiple tubular sections, connected by U-connectors and, therefore, the first tubular section is defined by the first tube, while the last tubular section is defined by the last tube. In an oscillatory tubular reactor, device 310 is connected to inlet 302 of the reactor in order to promote the oscillatory flow. For matters of scaling up, it is envisioned that additional reactors may be connected in parallel. Several tubular reactors operating in parallel can be modified to operate in a single shell, such as a shell and tube heat exchanger, with a defined number of tubular reactors inside. The oscillation system for the multiple reactors system can be composed of one or more pistons or other pressurization and depressurization devices.

### Examples

The values herein reported for experimental trials (Examples 1 and 5) were determined according to the following test methods.

Reaction yield (%): The conversion of the reaction was determined by the ratio between the VCM input mass, and the total polymer mass formed.

Detection of fouling: Visual detection of fouling inside the reactor at the end of the trial.

Particle size distribution (PSD): The particle size distribution of the powdered materials is obtained by laser beam deflection, using the Malvern Mastersizer 3000 equipment.

Weight average molecular weight (Mw), number average molecular weight (Mn) and polymer molecular weight distribution (MWD=Mw/Mn), were obtained through Gel permeation chromatography (GPC). A correlation based on the molecular weight Mw was used to calculate the K-value (VK) for the polymer.

Scanned Electron Microscopy (SEM), on a Phenon ProX/Thermosfisher microscope, to analyze morphology of the polymer particles

### Example 1: Polymerization of Vinyl Chloride in a Continuous Oscillatory Baffled Reactor

Assembly of Experiments:

The system described here refers to a production pilot unit for the continuous polymerization of vinyl chloride. The variables considered in the test were: vinyl chloride monomer (VCM) to water ratio, residence time (flow rates), oscillation frequency and amplitude, reaction temperature and recipe composition (chemicals).

The typical polymerization recipe for a suspension polymerization of vinyl chloride is presented in Table 1 and was followed for all the examples presented in this document.

TABLE 1
Typical Recipe for Suspension Polyvinylchloride
phm (parts per hundred monomer)

| | |
|---|---|
| VCM | 33 |
| Water(demineralized) | 66 |
| Dispersing agents | 0.05-0.25 |
| Initiator | 0.02-0.15 |
| Stabilizers | 0.0005-0.003 |

The variables considered in the trial were: vinyl chloride monomer concentration, residence time, mass flow rates, oscillation frequency and amplitude, and recipe composition (chemicals). Polymerization conditions for example 1 are indicated in Table 2:

TABLE 2
Polymerization Conditions for Experimental Trial

| | | Example 1 |
|---|---|---|
| Volume | L | 2.19 |
| Residence time | h | 1.5 |
| Total mass flow rate | g/h | 1,382.5 |
| VCM/(Water + VCM) | % w | 20% |
| Temperature | ° C. | 58 |
| Amplitude (mm) | mm | 10 |
| Frequency (Hz) | Hz | 2 |

The reactor for the continuous polymerization of vinyl chloride was an oscillatory baffled reactor, Hastelloy C22 material, volume of 2.5 liters, internal tube diameter 15 mm, 14 meters length and with a thermal jacket, supplied by Nitech (described in document U.S. Pat. No. 6,429,268 B1). The reactor was designed for a maximum temperature of 250° C. and pressure and 25 bar, in addition to having a flow range of 30 to 1500 mL/min.

High-pressure pumps and mass flow meters were chosen based on their performance to maintain constant and accurate flow rates at high pressures. The mass flow meters/controllers allow the precise mass-based control of the flow rate, avoiding density-related variations. The flow meters are coupled with the high-pressure pumps for the aqueous streams and with an actuated valve for the pure vinyl chloride stream.

Downstream of the oscillatory baffled reactor was installed a continuous stirred vessel, volume of 1 L, equipped with a backpressure regulation valve on its outlet. This type of valve is necessary to allow the release of product downstream, while maintaining the pressure inside the reactor. A key feature of the selected regulator is the ability to handle fluids with a high content of solids, since particles can typically cause malfunction in diaphragm- or spring-actuated backpressure regulators.

Polymerization reaction procedure:

The tested continuous process is based on the suspension polymerization process, in which vinyl chloride monomer, under pressure, is dispersed as droplets and polymerized using a free radical initiator, in an embodiment without pre-polymerization (as depicted in FIG. 1).

The reactor was first filled with water, and stabilized with oscillation control and heat jacket turned on until process temperature was reached and there were no peaks of pressure oscillation.

The vinyl chloride monomer and initiator mixtures were continuously fed to the oscillatory baffled reactor through an in-line static micromixer model R-600 Caterpillar, which determines the size of the droplets on the inlet of the reactor.

The reactor pressure was controlled at least 1.5 kgf/cm² above the vinyl chloride monomer vapor pressure (between 8.8 and 14.3 kgf/cm²g) by the back-pressure regulator valve.

The reaction is exothermic, and the temperature was controlled by the reactor cooling jacket, inside which cold water circulated.

After the reaction in the continuous oscillatory baffled reactor, the product followed to a continuous stirred vessel, installed right after the reactor. From the continuous stirred vessel, the product in aqueous suspension was collected in bottles, using a manual valve. All the process was maintained inside a fume hood, equipped with VCM sensors and all technicians involved in the process were equipped with safety masks.

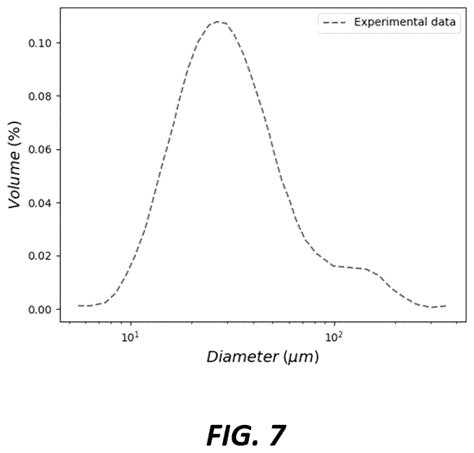

Samples of the product were collected, filtered, and analyzed. The results were evaluated according to reaction yield and K value, outlined in Table 3 and particle diameter distribution is illustrated in FIG. 7:

TABLE 3
Polymerization Results
Experimental Trial

| | | Example 1 |
|---|---|---|
| Final Reaction Yield | % | 58.0 |
| K value | — | 68.5 |

The particle size distribution in FIG. 7, related to the first sample, indicates an average diameter of 28,9 μm.

Due to the safety risks associated with handling higher concentrations of vinyl chloride monomer under temperature and high-pressure conditions in a pilot unit, inside a laboratory, and the cost involved in the bench/pilot scale runs, higher conversion tests were evaluated through a model system approach.

The experimental trials enabled the development and validation of a model for the suspension polymerization of poly vinyl chloride in oscillatory baffled reactors. The model comprises the transient mass and energy balances for each phase, equilibrium relationships and population balance equations to describe particle size distributions.

The mechanism of PVC suspension polymerization used in the model is based on a free radical polymerization mechanism which involves an initiator decomposition, chain initiation, propagation, transfer to monomer and bimolecular termination reactions. The molecular weight distribution (MWD) is calculated with the method of moments. A summary of the polymerization mechanism is presented in Table 4.

TABLE 4
Kinetic mechanism for PVC suspension polymerization
(Yuan et al. (1991).)

| Step | Mechanism |
|---|---|
| Initiator decomposition | $I {\to }^{{k}_{d}} 2 {I}^{*}$ |
| Chain initiation | ${I}^{*} + M {\to }^{{k}_{i}} {R}_{1}$ |
| Propagation | ${R}_{x} + M {\to }^{{k}_{p}} {R}_{x + 1}$ |
| Transfer to monomer | ${R}_{x} + M {\to }^{{k}_{tm}} {P}_{x} + {R}_{1}$ |
| Termination by disproportionation | ${R}_{x} + {R}_{y} {\to }^{{k}_{td}} {P}_{x} + {P}_{y}$ |
| Termination by combination | ${R}_{x} + {R}_{y} {\to }^{{k}_{tc}} {P}_{x + y}$ |

The main properties to describe polymer quality are the number average molecular weight (Mn), weight average molecular weight (Mw) and the K-Value (VK). An implicit BDF (Backwards Differentiation Formulas) algorithm was employed to solve the final system of ordinary integro-differential equations (ODEs) with absolute tolerance of 10⁻⁶.

### Example 2: Simulation of the Polymerization of Vinyl Chloride in a Continuous Oscillatory Baffled Reactor

Process conditions for the simulations are described in Table 5. For such simulations, three different scenarios were evaluated—s1, s2 and s3. The conditions of each scenario are specified in Table 5.

TABLE 5
Polymerization Conditions for Process Simulations

| | | s1 | s2 | s3 |
|---|---|---|---|---|
| Volume | L | 2.19 | 2.19 | 2.19 |
| Residence time | h | 1.5 | 2.2 | 2.2 |
| Total mass flow rate | g/h | 1382.5 | 921.7 | 921.7 |
| VCM/(Water + VCM) | % w | 25% | 25% | 47% |
| Temperature | ° C. | 58 | 58 | 58 |
| Amplitude (mm) | mm | 25 | 25 | 25 |
| Frequency (Hz) | Hz | 1 | 1 | 1 |
| Droplet average diameter | μm | 80 | 80 | 80 |

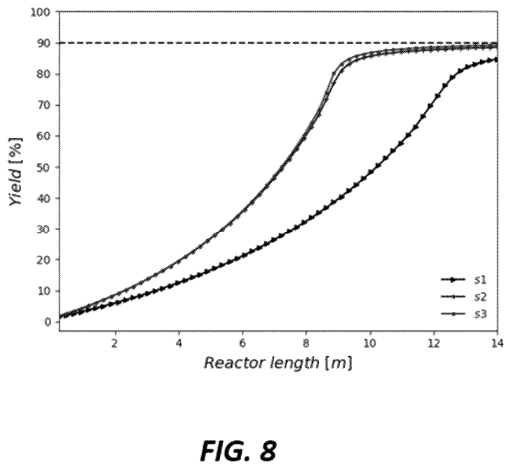

The conversion curves along the reactor for the three simulation scenarios are presented in FIG. 8. For scenarios 2 and 3, the conversion curves almost overlap because the initiator/monomer ratio and the residence time were kept constant. In scenario 1, the residence time is smaller. Consequently, the conversion profile looks delayed in comparison cases 2 and 3. The final conversion reached in simulation 1 is also lower.

The resulting molar masses, for the polymerization simulations, expressed as K value, are indicated in Table 6.

TABLE 6
Polymerization Simulation Results

| | | s1 | s2 | s3 |
|---|---|---|---|---|
| Final Reaction Yield | % | 84.7 | 88.5 | 89.2 |
| K value | — | 64.7 | 65.0 | 65.0 |

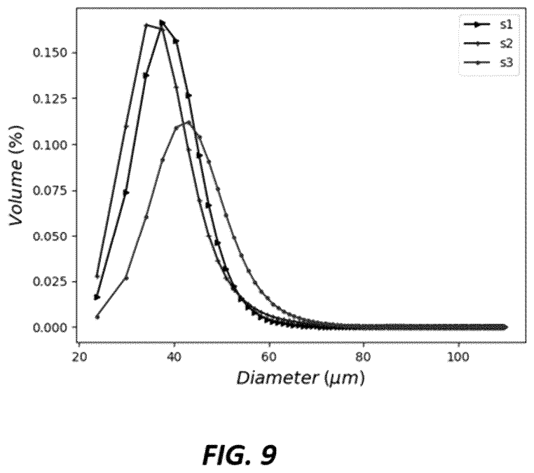

At the outlet of the reactor, the average particle size indicate particles are in the range of 35 to 40 μm. The particle size distributions for scenarios 1, 2 and 3 from Example 2 are depicted in FIG. 9.

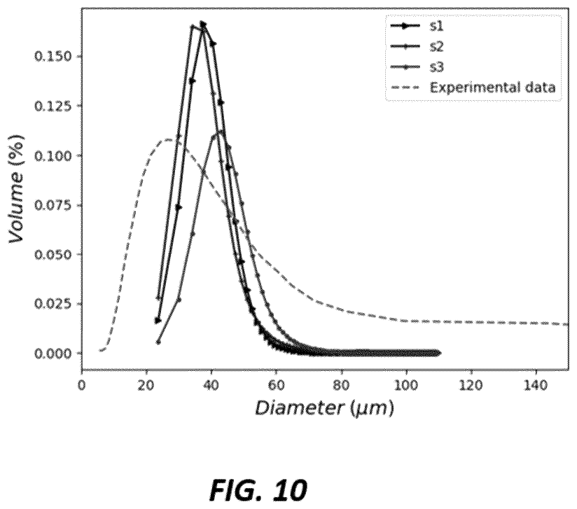

The results of average particle diameter in Example 2 are similar to the average particle diameter from experimental trial of Example 1, however with a narrow distribution according to FIG. 10.

### Example 3: Simulation of the Polymerization of Vinyl Chloride with Increased Diameter of Droplets on the Inlet of a Continuous Oscillatory Baffled Reactor

In Example 3 we intend to show the influence of the initial droplets size distribution on the particle size distribution at the outlet of the reactor.

In this example, the process conditions are the same as in Example 2, as presented in Table 7. However, the VCM droplets distribution at the inlet of the reactor is different, from Example 2. In this new example, the average diameter of VCM is 180 μm.

TABLE 7
Polymerization Conditions for Process Simulations

| | | s4 |
|---|---|---|
| Volume | L | 2.19 |
| Residence time | h | 1.5 |
| Total mass flow rate | g/h | 1382.5 |
| VCM/(Water + VCM) | % w | 25% |
| Temperature | ° C. | 58 |
| Amplitude (mm) | mm | 25 |
| Frequency (Hz) | Hz | 1 |
| Droplet average diameter | μm | 180 |

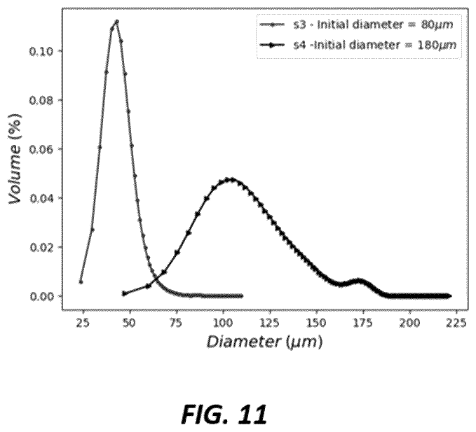

The results of these simulations show flexibility of the system to achieve higher particle average diameter, according to increased diameter of droplets in the inlet, as illustrated in Table 8 and FIG. 11.

TABLE 8
Polymerization Simulations with different VCM droplet
diameter distribution at the inlet of the reactor
Results

| | | s3 | s4 |
|---|---|---|---|
| Final Reaction Yield | % | 89.2 | 89.5 |
| K value | — | 65.0 | 65.4 |

### Example 4: Energy Dissipation in a Continuous Oscillatory Reactor with a Twisted Tube and Baffled Tube

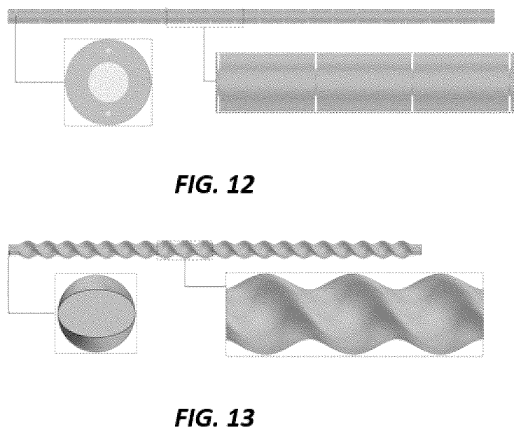

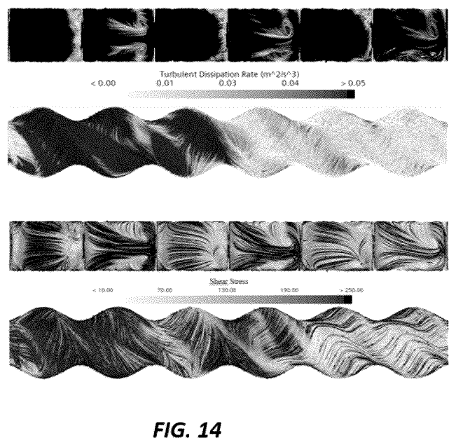

Through Computational Fluid Dynamics (CFD) analysis, two different internal tube configurations were compared in terms of energy dissipation: the baffled tube and the twisted tube, presented in FIG. 12 and FIG. 13. FIG. 12 represents the computational domain for the baffled tube, with the cross-section area and a detail of the reactor cells and FIG. 13 represents the computational domain of the twisted tube, with the cross-section area and a detail of the reactor torsions.

Energy dissipation is an important parameter in different processes, since it impacts material and energy balances, mixture quality, and so on. In short, energy dissipation, being related to the velocity gradient, can be associated with shear stress, a variable that affects the dispersed/solid phase morphology in a multiphase system.

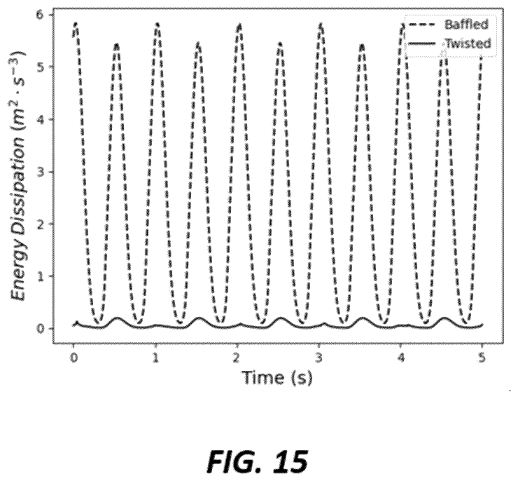

Streamlines and time-average values for energy dissipation during a flow cycle in a baffled tube oscillatory reactor and in a twisted tube oscillatory reactor are depicted in FIG. 14.

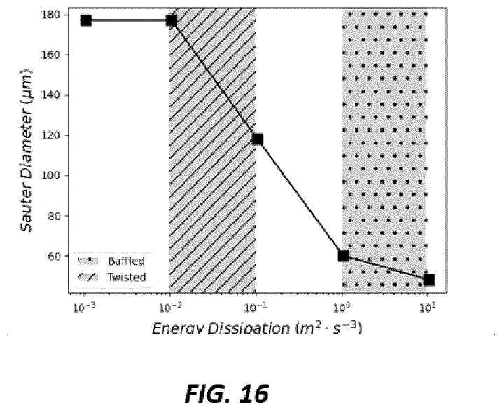

The comparison of energy dissipation in a baffled tube and a twisted tube is presented in FIG. 15. The dissipated energy is 38.5 times higher in baffled tube, compared to the twisted tube due to higher shear rates in the baffled tubes.

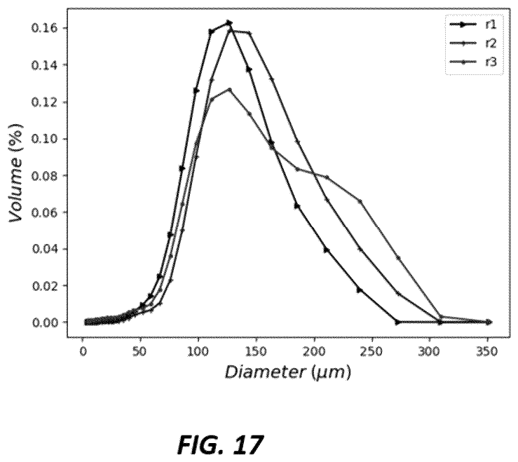

The correlation between particle diameter and energy dissipation, illustrated in FIG. 16, indicates that for the lower energy dissipation in the system, higher is the expected average particle diameter of the polymer. It is important to highlight, as previously commented, the correlation between the average diameter of the final particle and the dissipated energy is also sensitive to changes in the initial distribution of droplet size, which is a parameter that can be defined to reach the diameter of interest.

Therefore, for the exact same process conditions, baffled tubes can be used in the oscillatory reactor when smaller average particle diameters are desired, and alternatively, the twisted tubes are a possibility to increase average particle diameter of the polymer produced.

### Example 5: Pre-Polymerization Reactor Upstream of the Vinyl Chloride Polymerization in the Continuous Oscillatory Reactor

Example 5 shows the effect of a pre-polymerization step prior to the main polymerization reaction in order to stabilize polymer particles that will be fed to the oscillatory reactor. The set up for the pre-polymerization system consists of a stainless-steel batch reactor, jacketed with a water circulation system for cooling and heating, and an agitator with three curved blades (diameter 60 mm). Process conditions are shown in Table 9.

TABLE 9
Pre-Polymerization Conditions for Experimental Trials

| | | r1 | r2 | r3 |
|---|---|---|---|---|
| Volume | L | 2 | 2 | 2 |
| Residence time | min | 187 | 40 | 30 |
| VCM/(Water + VCM) | % w | 33% | 33% | 33% |
| Temperature | ° C. | 58 | 58 | 58 |
| Initiator concentration | phm* | 0.075 | 0.075 | 0.065 |
| Rotation Speed | rpm | 200 | 200 | 200 |

*parts per hundred of monomer.

For the pre-polymerization experiments, as described in Example 5, the recipe follows the proportions indicated in Table 10.

TABLE 10
Recipe for Pre-Polymerization
phm (parts per hundred of monomer)

| | |
|---|---|
| VCM | 33 |
| Water(demineralized) | 66 |
| Dispersing agents | 0.05-0.25 |
| Initiator | 0.02-0.15 |
| Stabilizer | 0.0005-0.003 |

The reactor was charged with demineralized water, initiators and suspending agents. After the reactor was closed, vacuum was applied to remove all traces of oxygen in the system. The VCM was loaded into the reactor, and the mixture was stirred at 200 rpm for 10 min at room temperature, then the reactor temperature was increased to 58° C. Through the experiments, residence time and the amount of reaction initiator were varied.

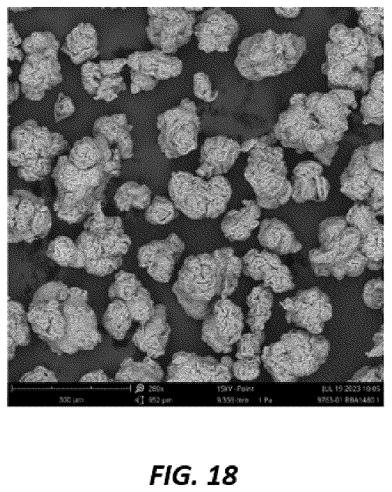

After the determined residence time, the reaction was stopped by cooling the reactor, and reducing its pressure to remove unconverted VCM. The unconverted monomer was recovered, and the reaction product was filtered, dried for 2.0 h, in an oven at 80° C. and analyzed. The results of particle diameter distribution are illustrated in FIG. 17.

The pre-polymerization experimental trials indicate that on a lower residence time, r3, the particle diameter distribution is broader and can even show a slight bimodality compared to experimental trial r1, which represents a full reaction in the pilot batch reactor. Experimental trial r2, with an intermediate residence time, shows a narrower distribution, which is a characteristic to well stabilized polymer particles.

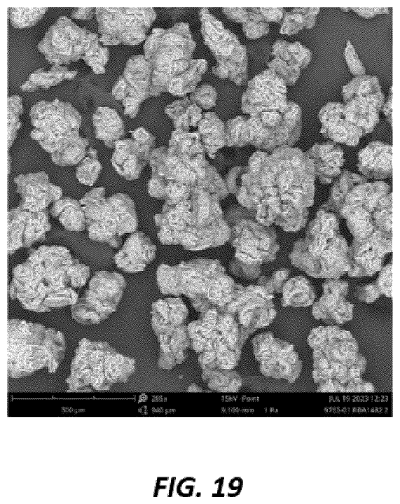

Additionally, images registered through scanned electron microscopy (SEM), here presented in FIG. 18 and FIG. 19, indicate that the particles formed on the pre-polymerization trials have a stabilized diameter and morphology, therefore indicating that a pre polymerization step, upstream of the polymerization reactor, can improve particle morphology of the poly vinyl chloride in the continuous oscillatory reactor.

While the scope of the composition and method will be described with several embodiments, it is understood that one of ordinary skill in the relevant art will appreciate that many examples, variations and alterations to the composition and methods described here are within the scope and spirit of the disclosure. Accordingly, the embodiments described are set forth without any loss of generality, and without imposing limitations, on the disclosure. Those of skill in the art understand that the scope includes all possible combinations and uses of particular features described in the specifications.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed is:

1. A process for polymerization of vinyl chloride, comprising:
contacting vinyl chloride, demineralized water, at least one stabilizer agent, at least one dispersing agent and optionally one or more comonomers (herein referred to as the pre-mixture);
continuously feeding the vinyl chloride, demineralized water, the at least one stabilizer agent, the at least one dispersing agent and optionally one or more comonomers into a tubular reactor having a length of at least 20 times the internal diameter of the tubular reactor; and continuously polymerizing the vinyl chloride, and optionally the one or more comonomers.

2. The process of claim 1, further comprising: vaporizing unreacted vinyl chloride and venting it into a vinyl chloride monomer treating system for recovery.

3. The process of claim 1, further comprising collecting reaction medium in a vessel at the exit of the reactor, pressurized with inert gas, acting as a pulsation damper of the reactor, to prevent pressure oscillation effects therein.

4. The process of claim 3, further comprising: centrifugation and drying of polyvinylchloride from the reaction medium.

5. The process of claim 1, further comprising feeding the pre-mixture into a piston pump suction and subsequently discharging the pre-mixture from piston pump into the reactor.

6. The process of claim 1, further comprising feeding an initiator into the tubular reactor at a distance of at least 10 times the internal diameter of the tubular reactor from the piston pump discharge point.

7. The process of claim 6, wherein the initiator is fed into the tubular reactor at a plurality of points.

8. The process of claim 1, wherein the pre-mixing occurs, continuously or in batch, in a stirred reactor, a loop reactor, or in a tubular reactor.

9. The process of claim 1, wherein pre-mixing occurs within the tubular reactor.

10. The process of claim 1, further comprising preliminary polymerizing the vinyl chloride and optionally the one or more comonomers by feeding an initiator of the polymerization in an amount to promote the preliminary polymerization.

11. The process of claim 1, wherein the pre-mixing occurs at a temperature from 10° C. to 60° C.

12. The process of claim 1, where the stabilizer agent is at least one among a phenolic compound, alkyl/aryl phosphites, epoxy compounds, modified soy oils, beta-diketones, amino crotonates, nitrogen heterocyclic compounds, organosulfur compounds, hindered phenolics, and polyols.

13. The process of claim 1, where the dispersing agent is a polyvinyl alcohol, a cellulosic compound or mixtures thereof.

14. The process of claim 1, where the one or more comonomers is vinyl acetate.

15. The process of claim 1, where the concentration of vinyl chloride is at least 10 wt % and up to 60 wt %, based on the amount of demineralized water.

16. The process of claim 1, where the tubular reactor is an oscillatory tubular reactor.

17. The process of any of claim 16, wherein the oscillatory tubular reactor has internal baffles.

18. The process of claim 17, wherein the internal baffles are selected from the group consisting of central axial baffles, round-edged helical baffles, wire wool baffles, single-orifice baffles, disc and doughnut baffles.

19. The process of claim 16, wherein a wall of the tubular reactor is shaped to create obstacles within the tubular reactor, such wall being selected from the group consisting of twisted profiles or corrugated tubes.

20. The process of claim 1, wherein the polymerization is at a temperature ranging from 30° C. to 80° C.

21. The process of claim 1, wherein the polymerization has a residence time of up to 180 min.

22. The process of claim 1, wherein the polymerization is at a total pressure ranging from 10 to 40 barg.

23. The process of claim 1, wherein the polymerization occurs with an oscillatory movement within the tubular reactor, where the frequency of the oscillatory movement is at up to 5 Hz and the amplitude of the oscillatory movement is at up to 10 times the internal diameter of the tubular reactor section.

24. The process of claim 1, wherein the polymerization occurs in the tubular reactor and one or more additional reactors and wherein the inlet of one or more additional reactors are connected to an outlet of a previous reactor.

25. The process of claim 1, wherein the polymerization occurs in suspension type process.

26. The process of claim 1, wherein the polymerization occurs in an emulsion type reaction.

27. A vinyl chloride polymer or copolymer thereof, produced by claim 1.
